(19) United States
(12) Patent Application Publication
(10) Pub. No.: US 2013/0299013 A1
(43) Pub. Date: Nov. 14, 2013

(54) HYDRAULIC UNIT WITH FLEXIBLE PORT LOCATION

(71) Applicant: Bernhard Gnamm, Vaihingen-Enz (DE)

(72) Inventor: Bernhard Gnamm, Vaihingen-Enz (DE)

(73) Assignee: ROBERT BOSCH GMBH, Stuttgart (DE)

(21) Appl. No.: 13/470,658

(22) Filed: May 14, 2012

(51) Int. Cl. F15B 13/00

(52) U.S. Cl. 137/544; 137/565.01

(57) ABSTRACT

A hydraulic unit for a braking system includes at least one motor-driven pump. A pump housing is configured to receive the at least one motor-driven pump. A plurality of connection ports are provided in the pump housing as bores intersecting an exterior surface of the pump housing and configured to be fluidly coupled with corresponding external brake lines. A plurality of internal fluid passages are provided inside the pump housing, including a plurality of connector passages, each in direct fluid communication with a corresponding one of the plurality of connection ports. At least one of the plurality of connection ports defines a first axis that is offset from a second axis defined by the corresponding connector passage

### BACKGROUND

The present invention relates to hydraulic units, which may be used in automotive anti-lock braking systems. More particularly, the invention relates to connection port layout for hydraulic units. Although a pump housing of a hydraulic unit may be generally adaptable to use in a variety of actual applications (e.g., different vehicles), connection port locations may need to be varied. Typically, specialization for locating the connection ports and the internal passages in direct communication therewith is a prime source of added cost for the manufacturer in need of satisfying the various needs of multiple applications.

### SUMMARY

In one aspect, the invention provides a hydraulic unit for a braking system. At least one motor-driven pump is provided, and a pump housing is configured to receive the at least one motor-driven pump. A plurality of connection ports are provided in the pump housing as bores intersecting an exterior surface of the pump housing and configured to be fluidly coupled with corresponding external brake lines. A plurality of internal fluid passages are provided inside the pump housing, including a plurality of connector passages, each in direct fluid communication with a corresponding one of the plurality of connection ports. At least one of the plurality of connection ports defines a first axis that is offset from a second axis defined by the corresponding connector passage.

Other aspects of the invention will become apparent by consideration of the detailed description and accompanying drawings.

### BRIEF DESCRIPTION OF THE DRAWINGS

FIG. 1 is a perspective view of a hydraulic unit schematically represented in a vehicle ABS system.

FIG. 2 is a schematic view of the hydraulic unit of FIG. 1.

FIG. 3 is a perspective view of a pump housing and port inserts of the hydraulic unit.

FIG. 4 is a top view of the pump housing illustrating a possible arrangement of brake-side connection ports.

FIG. 5 is a cross-sectional view of one brake-side connection port of the hydraulic unit, taken along line 5-5 of FIG. 4.

FIG. 6 is a cross-sectional view similar to FIG. 5, but illustrating a connection port of a second construction.

FIG. 7 is a cross-sectional view similar to FIG. 5, but illustrating a connection port of a third construction.

FIG. 8 is a top view of a pump housing of the prior art.

FIG. 9 is a cross-sectional view of the prior art pump housing, taken along line 9-9 of FIG. 8.

FIG. 10 is a partial cutaway side view of one of the port inserts of FIGS. 3-5.

FIG. 11 is a side view of an alternate port insert.

FIG. 12 is a cross-sectional view illustrating one optional interior construction of the alternate port insert of FIG. 11.

FIG. 13 is a cross-sectional view illustrating another optional interior construction of the alternate port insert of FIG. 11.

FIG. 14 is a cross-sectional view illustrating yet another optional interior construction of the alternate port insert of FIG. 11.

FIG. 15 is a cross-sectional view illustrating yet another optional interior construction of the alternate port insert of FIG. 11.

FIG. 16 is a perspective view of another alternate port insert.

FIG. 17 is a cross-sectional view illustrating one optional interior construction of the alternate port insert of FIG. 16.

FIG. 18 is a cross-sectional view illustrating another optional interior construction of the alternate port insert of FIG. 16.

FIG. 19 is a perspective view of a hydraulic unit featuring another alternate type of port insert.

FIG. 20 is a perspective view of the hydraulic unit of FIG. 19 with the port inserts removed to illustrate a mounting surface of the pump housing.

FIG. 21 is a cross-sectional view illustrating one optional interior construction of the alternate port insert of FIG. 19.

FIG. 22 is a cross-sectional view illustrating another optional interior construction of the alternate port insert of FIG. 19.

FIG. 23 is a perspective view of a hydraulic unit featuring yet another alternate type of port insert.

FIG. 24 is a perspective view of the hydraulic unit of FIG. 23 with the port inserts removed to illustrate a mounting surface of the pump housing.

FIG. 25 is a cross-sectional view illustrating one optional interior construction of the alternate port insert of FIG. 23.

FIG. 26 is a cross-sectional view illustrating another optional interior construction of the alternate port insert of FIG. 23.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

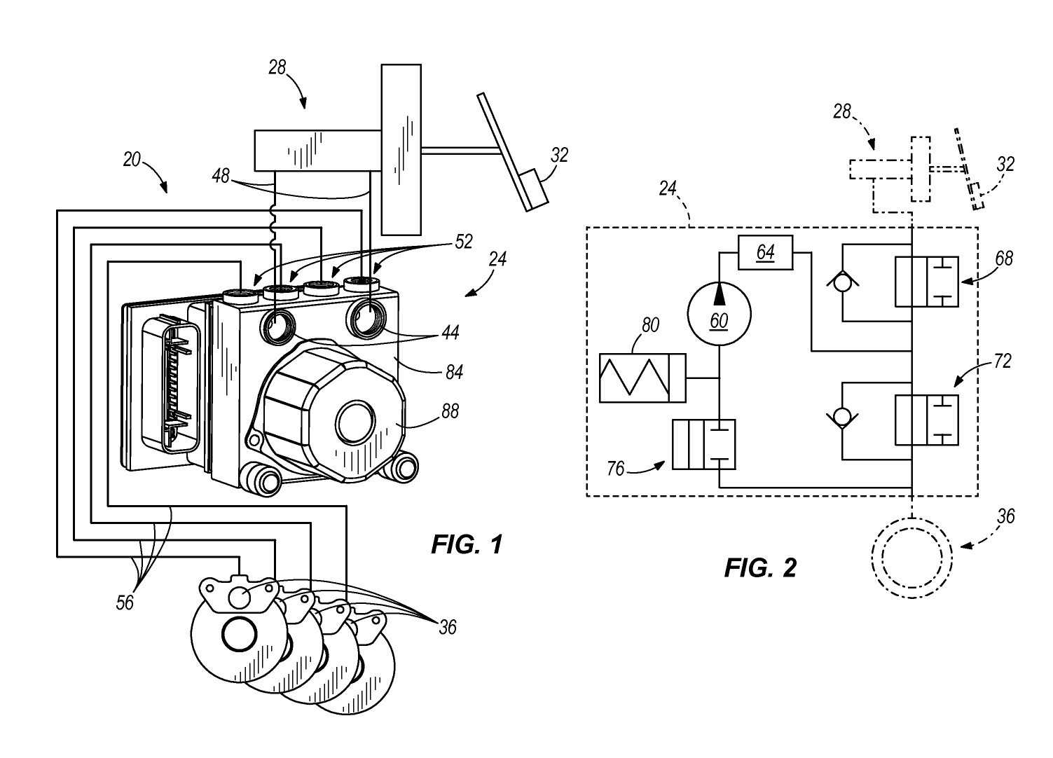

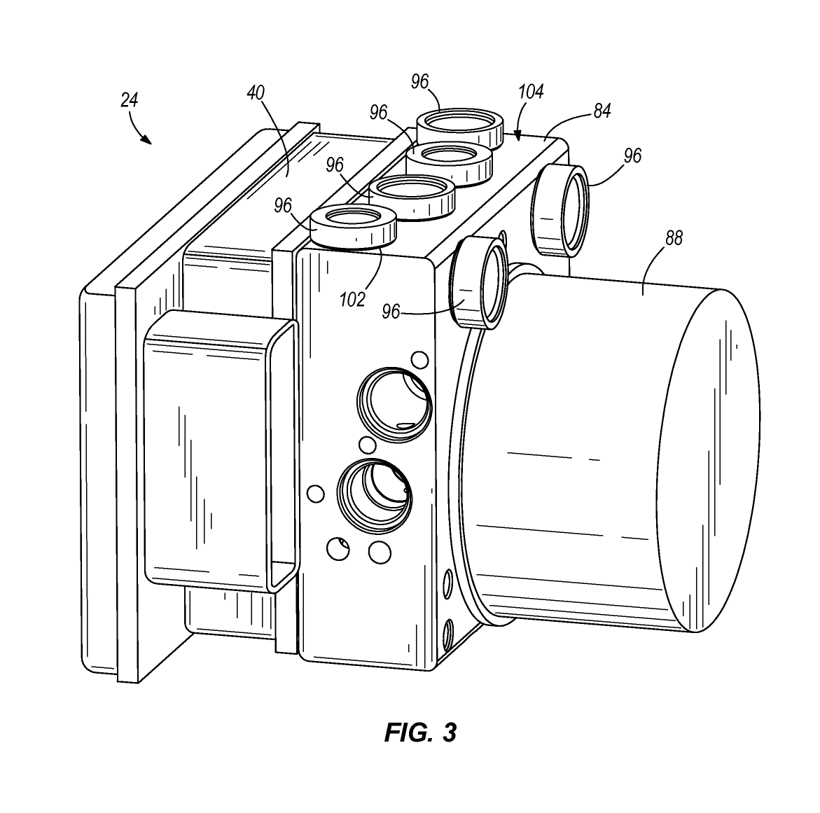

An anti-lock braking system 20 (ABS or ABS system) is shown in FIG. 1. The ABS system 20 is provided in a wheeled vehicle for preventing wheel lockup and skidding under hard braking events or braking on low friction surfaces. The ABS system 20 includes as its primary mechanical component a hydraulic unit 24 coupled between a brake master cylinder 28 (actuated by a user-operable brake pedal 32) and a plurality of wheel cylinders 36. Although the wheel cylinders 36 are shown in FIG. 1 as being incorporated with calipers of a disc braking system, other types of hydraulic braking systems may be provided at each of the wheels. The hydraulic unit 24 controls the selective relief of hydraulic fluid pressure from the wheel cylinders 36 so that a braking force just below the traction limit is maintained. A plurality of sensors (not shown) are coupled to a controller portion 40 (FIG. 3) of the hydraulic unit 24 to provide input information, typically regarding relative wheel speeds, so that the controller 40 can control the operation of the hydraulic unit 24. The hydraulic unit 24 may also be configured to provide brake force distribution and/or traction control as part of an overall electronic stability program (ESP) of the vehicle since many of the same hardware components are already provided by the ABS system 20. Although the hydraulic unit 24 can be used in automotive braking systems with anti-lock and other functionality, its application is not limited to such systems.

The hydraulic unit 24 includes a pair of connection ports 44 for communicating hydraulic fluid back and forth with the master cylinder 28 along two brake lines 48 connected to the respective ports 44. Additional connection ports 52 of the hydraulic unit 24 mate with individual brake lines 56 for each respective wheel cylinder 36 of the ABS system 20 so that hydraulic fluid can be exchanged back and forth between the hydraulic unit 24 and each individual wheel cylinder 36. The hydraulic unit 24 is shown in greater detail in FIGS. 2-5.

Along with the external brake lines 48, 56, the hydraulic unit 24 defines a fluid circuit between the master cylinder 28 and each of the wheel cylinders 36. As shown in FIG. 2, the following elements are provided in each fluid circuit of the hydraulic unit 24: at least one pump 60, a damper 64 (optionally eliminated or built into the pump 60), a suction control valve 68, an inlet valve 72, an outlet valve 76, an accumulator 80, and a plurality of fluid passages establishing connections between the various elements. FIG. 2 is a basic schematic for one of the wheel cylinders 36, but it should be understood that components such as the inlet and outlet valves 72, 76 are individually provided for each wheel cylinder 36, while other components may be shared among the circuits for the various wheel cylinders 36. For example, the hydraulic unit 24 of FIG. 1 (for the exemplary four wheel ABS system 20) includes a body or pump housing 84. The pump housing 84 can be a one-piece cast or machined block, for example of aluminum, but other materials and multi-piece configurations are optional. The pump(s) 60 are received within the pump housing 84 in corresponding bores. The pump(s) 60 are driven by a motor 88 coupled to the side of the pump housing 84. The pump housing 84 also houses two accumulators 80. In the illustrated construction, each accumulator 80 is configured to receive hydraulic fluid from two of the wheel cylinders 36 through the respective outlet valves 76, but other configurations are optional.

Although the basic operation of the ABS system 20 will already be understood to one of ordinary skill in the art, it is briefly discussed below. When the brakes are actuated by the driver (via the pedal 32), hydraulic fluid is forced from the master cylinder 28 into the hydraulic unit 24 via the “actuator-side” connection ports 44. Hydraulic fluid is transmitted through the normally-open suction control valve 68 and the normally-open inlet valve 72 to the wheel cylinders 36 via the “brake-side” connection ports 52. The inlet valve 72 is operable between the open condition and a closed condition, which prevents excess pressure applied to the pedal 32 from being transmitted to the wheel cylinders 36. When the controller 40 determines that the brake-induced traction limit has been reached, the inlet valve(s) 72 are closed and the normally-closed outlet valve(s) 76 are opened to relieve hydraulic fluid from the wheel cylinder(s) 36 via the at least one brake-side port 52. The hydraulic fluid is directed into the corresponding accumulator 80 from which location it can later be pumped by the pump(s) 60, through the damper 64 and the suction control valve 68, back to the master cylinder 28.

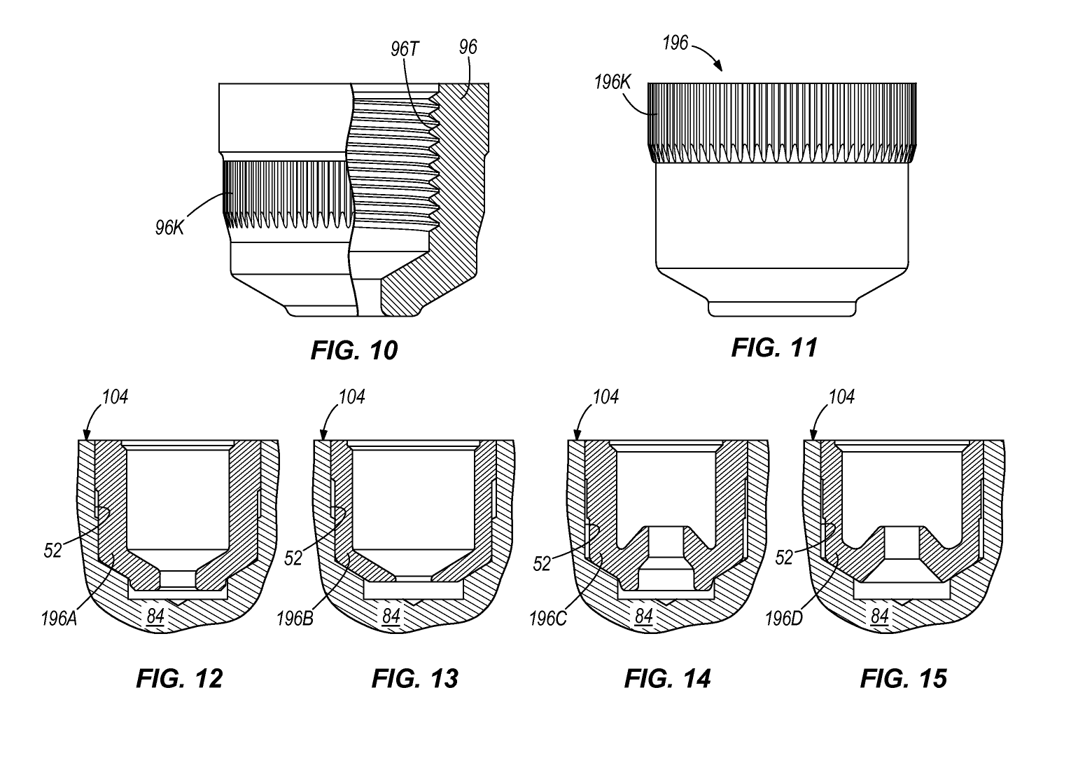

As shown in FIGS. 3-5, the brake-side connection ports 52 are formed as bores directly adjacent an exterior surface 104 of the pump housing 84. In the illustrated construction, all of the brake-side connection ports 52 intersect the exterior surface 104, which is a single planar surface of the pump housing 84. Each bore has a bottom end 52A (i.e., at the maximum depth of the bore) in direct fluid communication with an internal connector passage 90. In the illustrated construction, a port insert 96 is received in each bore and is configured to establish the coupling (both mechanically and fluidly) between one of the external brake lines 56 and the pump housing 84. The port inserts 96 can be constructed of metal and pressed into the corresponding bores to establish a sealed connection. Additional detail of one of the exemplary port inserts 96 is illustrated in FIG. 10. Each port insert 96 can include female threads 96T that receive and engage male threads of a corresponding compression fitting 98, such that tightening of the compression fitting 98 into the port insert 96 clamps the external brake line 56 to mechanically and fluidly couple the external brake line 56 with the pump housing 84. A knurled portion 96K on the exterior of the port insert 96 serves to provide a torque-resisting secure attachment between the port insert 96 and the corresponding bore.

As best shown in FIG. 5, each port insert 96 is insertable into the bore of the brake-side connection port 52 but does not reach the bottom end 52A of the bore. For example, the port insert 96 can abut a shoulder 100 as shown. The port insert 96 can also have an annular rib 102 configured to abut the exterior surface 104 of the pump housing 84. From either or both of these abutments, the port insert 96 is positively positioned relative to the bore and the bottom end 52A thereof to provide space between the port insert 96 and the bottom end 52A of the bore. Thus, the port inserts 96 do not extend into the internal connector passages 90 whatsoever.

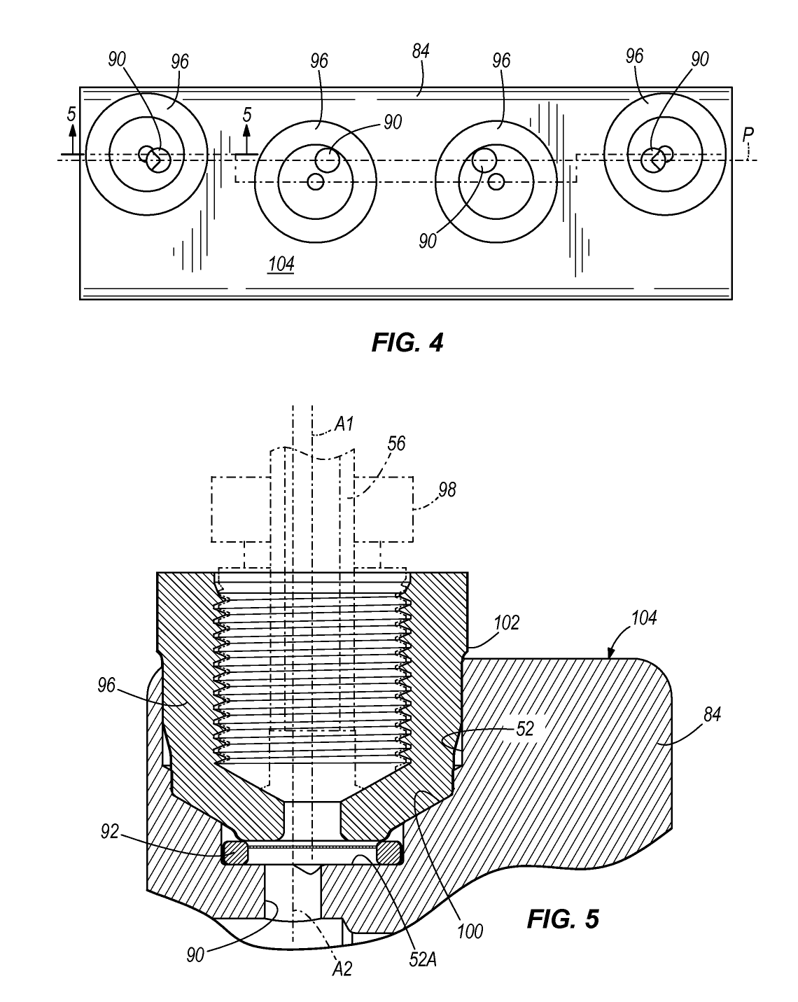

The bore forming each brake-side connection port 52 defines a central axis A1. Likewise, each connector passage 90 defines a central axis A2. In the illustrated construction, the central axes A1 are parallel to the axes A2, but as described further herein, the axes A1, A2 are not necessarily coaxial. Of the plurality of brake-side connection ports 52, at least one of the central axes A1 thereof is offset from the axis A2 of the corresponding internal connector passage 90. In some constructions, as illustrated, the axes A1 of all of the brake-side connection ports 52 are offset from the axes A2 of the corresponding internal connector passages 90. As shown in FIG. 4, the internal connector passages 90 for all of the brake-side connection ports 52 are arranged in a row to define a common plane P. One or more (up to all) of the brake-side connection ports 52 can be arranged so that their axes A1 are not in the plane P defined by the internal connector passages 90. This arrangement, in which the positioning of the internal connector passages 90 does not necessarily determine the positioning of the brake-side connector ports 52, allows for the pump housing 84 to be easily customized to any of a wide variety of desired brake-side connector port layouts without modifying the layout of the internal connector passages 90.

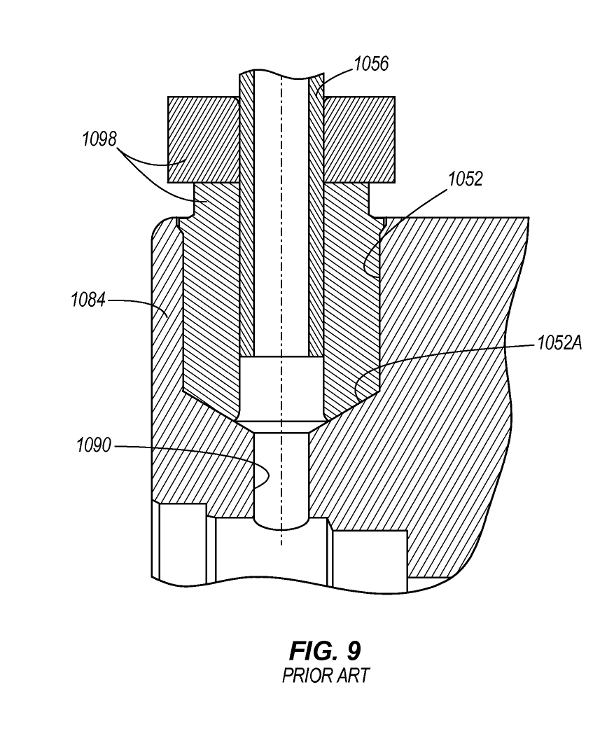

As mentioned above, the port inserts 96 do not extend into the internal connector passages 90, and in fact, are spaced from the bottom ends 52A of the corresponding bores forming the brake-side connection ports 52. The spaces not only provide the flexibility for locating the ports 52 offset from the internal connector passages 90, but also function to receive filters 92, which prevent or inhibit the passage of debris that may be present in the hydraulic fluid. The port insert 96 can be dimensioned to contact and optionally press upon the filter 92 in the fully seated position. As shown in FIGS. 8 and 9, conventional arrangements utilize a pump housing 1084 in which each brake-side connection port 1052 is coaxially aligned with the corresponding underlying internal connector passage 1090, and furthermore, the external brake line 1056 is connected with the pump housing 1084 with a compression fitting 1098 that engages directly with the bore of the port 1052 (i.e., by threading into the bore) and contacts the bottom 1052A of the bore. Thus, no universality can be achieved with the manufacturing of the internal connector passages 1090 when different arrangements or orientations of external brake lines 1056 and ports 1052 are required, and no space at the ports 1052 is provided for receiving a filter.

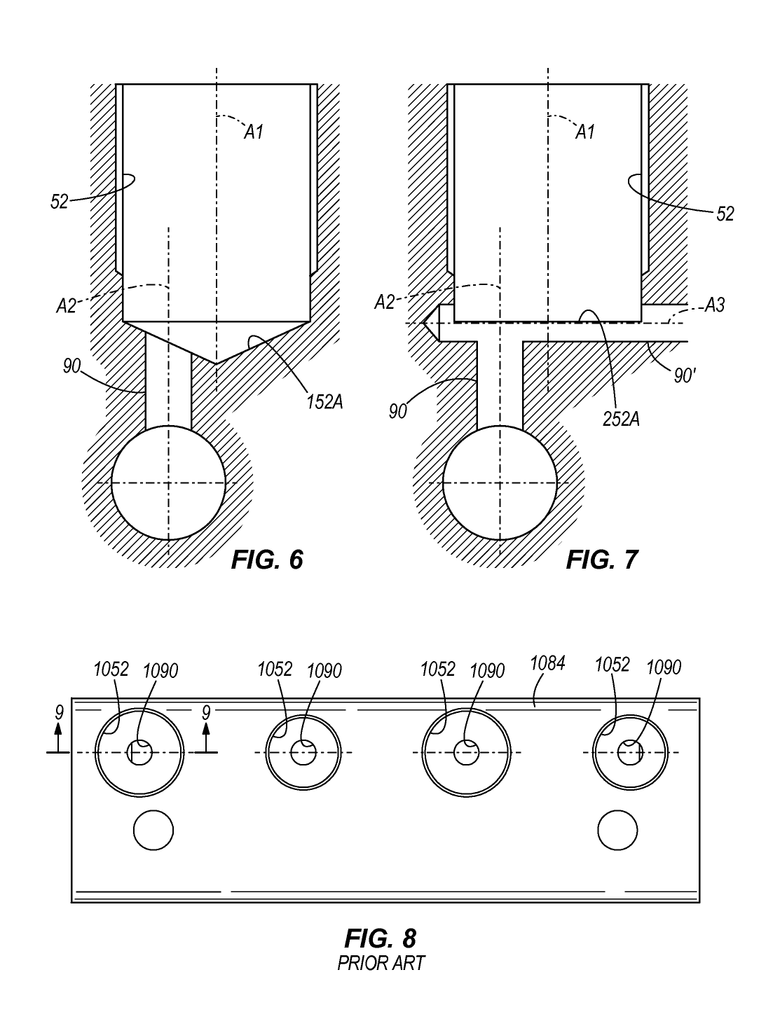

As shown in FIG. 5, the bottom end 52A of each brake-side connection port 52 is a substantially flat wall extending transverse to the axis A1 of the bore, and the internal connector passage 90 intersects with the substantially flat bottom end 52A. However, alternate constructions as shown in FIGS. 6 and 7 are optional. FIG. 6 illustrates a construction in which the bore forming the brake-side connection port 52 includes a conical tapered bottom end 152A that is not perpendicular to the axis A1. The corresponding internal connector passage 90 intersects with the conical tapered bottom end 152A at a “skewed” interface. FIG. 7 illustrates a construction in which the bottom end 252A of the bore forming the brake-side connection port 52 is a substantially flat wall extending transverse to the axis A1 of the bore like that of FIG. 5. However, as shown in FIG. 7, multiple internal connector passages 90, 90′ are provided at the bottom end 252A, including a first internal connector passage 90 centered on the axis A2 parallel with the axis A1, and a second internal connector passage 90′ centered on an axis A3 that is substantially perpendicular to the axes A1, A2, and that may be coincident or in-plane with the bottom end 252A. The second internal connector passage 90′ extends generally across the bottom end 252A of the bore, or a portion thereof, such that the first and second internal connector passages 90, 90′ intersect at the bottom end 252A.

As shown in FIGS. 3 and 5, the port inserts 96 are inserted into the corresponding brake-side connection ports 52 so that a majority of each insert 96 is below the exterior surface 104 of the pump housing 84, while the rib 102 ensures that a portion of each port insert 96 remains exposed above the exterior surface 104. FIG. 11 illustrates a port insert 196 of an alternate construction which is configured to be completely received into the brake-side connection port 52. The knurled portion 196K on the exterior of the port insert 196 is provided at the upward or outward end having a slightly increased diameter, similar to the rib 102 of the port insert 96. FIGS. 12-15 illustrate various internal shapes or configurations for the port insert 196 of FIG. 11, with the different variations being labeled as 196A-D. The various internal shapes or configurations can also be provided in the port inserts 96 of FIGS. 3 and 5, and are configured to accommodate a variety of brake line and/or fitting sizes or types. Of course, other constructions for accommodating additional brake line and/or fitting sizes and types can also be provided. As shown in FIGS. 12-15, each of the port inserts 196A-D is substantially flush with the exterior surface 104 of the pump housing 84 when fully inserted.

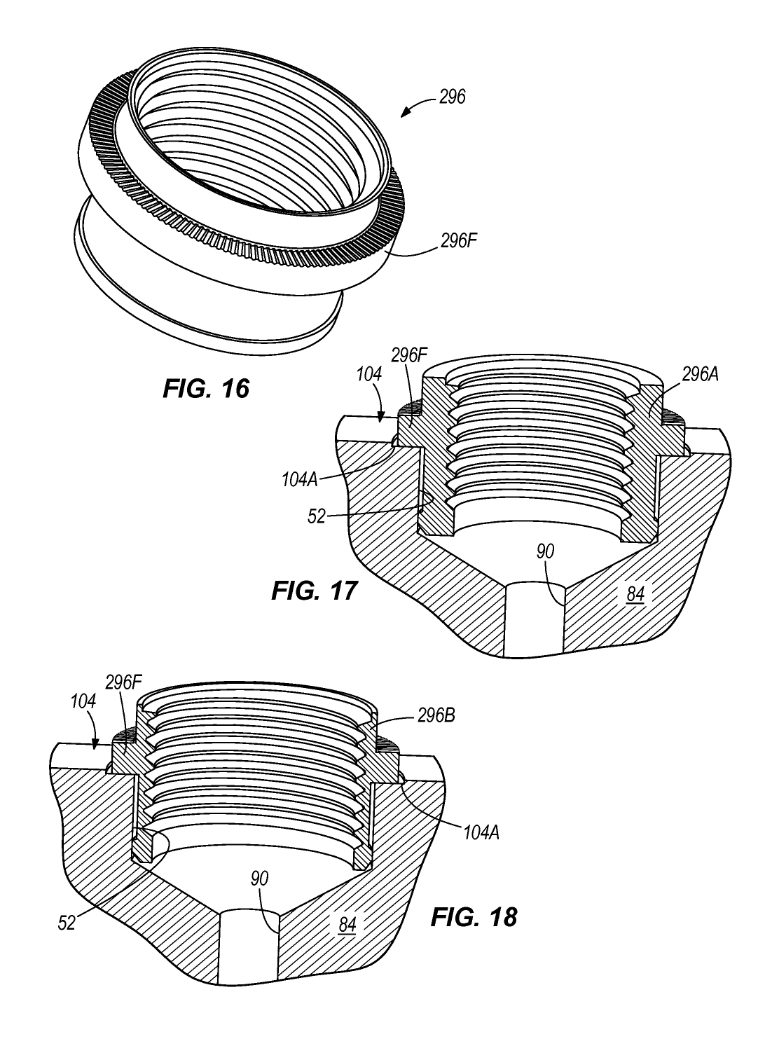

FIG. 16 illustrates another alternate port insert construction, identified as 296. The port insert 296 does not have any knurled portion on its exterior for engaging with a brake-side connection port 52. Rather, the port insert 296 includes a radially-protruding flange 296F that is slightly larger than the diameter of the corresponding brake-side connection port 52. The flange 296F enables the port insert 296 to be inserted into the corresponding brake-side connection port 52 to a maximum depth where the flange 296F abuts the exterior surface 104 of the pump housing 84. The flange 296F also provides a location for welding the port insert 296 to the pump housing 84. In particular, the pump housing 84 is modified with a shallow counterbore 104A at each of the brake-side connection ports 52 for receiving the flange 296F, and the flange 296F can be ultrasonically welded to the pump housing 84. Other constructions and processes may alternately be provided. FIGS. 17 and 18 illustrate two particular constructions 296A, 296B, each conforming to the above description of the port insert 296, but being provided with alternate interior configurations (i.e., different internal threads) to accommodate various brake line fittings.

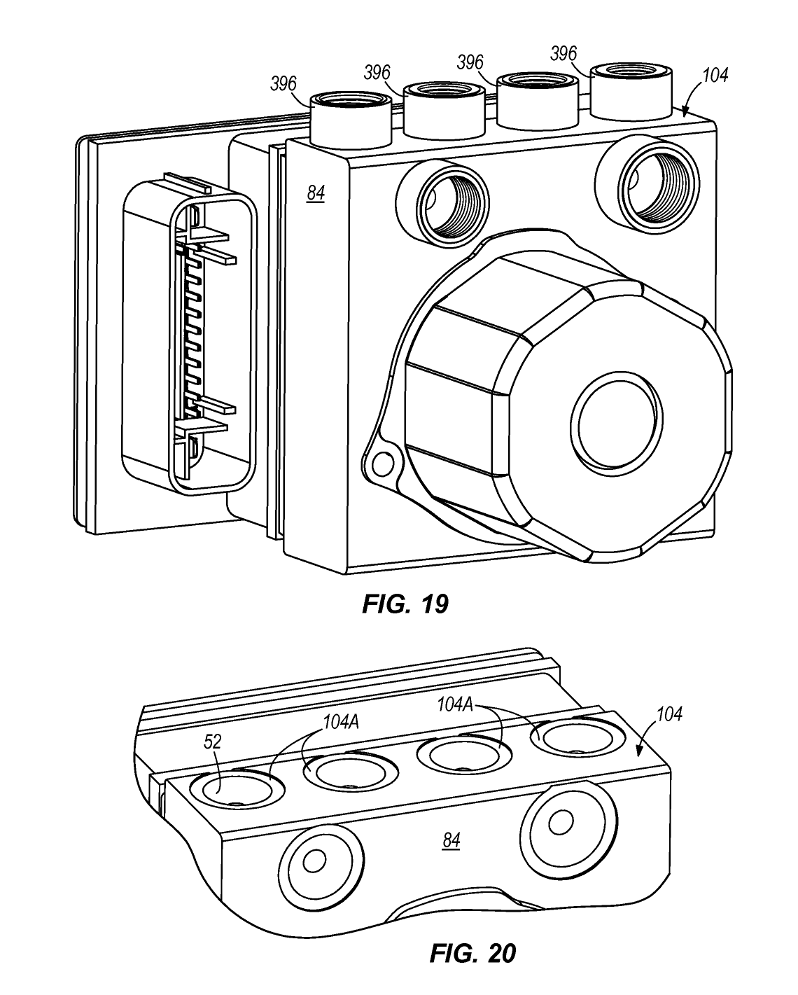

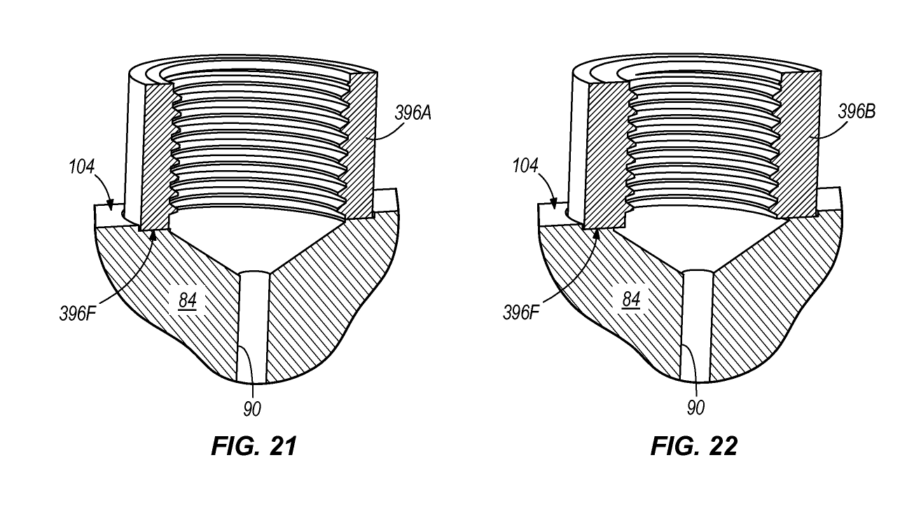

FIG. 19 illustrates another alternate port insert construction, identified as 396. The port inserts 396 do not have any knurled portion on their exterior for engaging with a brake-side connection port 52. In fact, the port inserts 396 are not positioned inside the bores of the corresponding brake-side connection ports 52. Rather, the port inserts 396 are positioned on the exterior surface 104 of the pump housing 84. Thus, the port insert 396 may also be referred to as an onsert. The port insert 396 has a proximal axial end face 396F (see FIGS. 21 and 22) for welding the port insert 396 to the pump housing 84. In particular, the pump housing 84 is modified with a shallow counterbore 104A at each of the brake-side connection ports 52 as shown in FIG. 20 for receiving the axial end face 396F of the port insert 396, and the axial end face 396F can be ultrasonically welded to the pump housing 84. Other constructions and processes may alternately be provided. FIGS. 21 and 22 illustrate two particular constructions 396A, 396B, each conforming to the above description of the port insert 396, but being provided with alternate interior configurations (i.e., different internal threads) to accommodate various brake line fittings. As will be appreciated from the drawings, the brake lines and brake line fittings associated with any of the port inserts 396 are positioned substantially outside the exterior surface 104 of the pump housing 84 when coupled to the corresponding port insert 396.

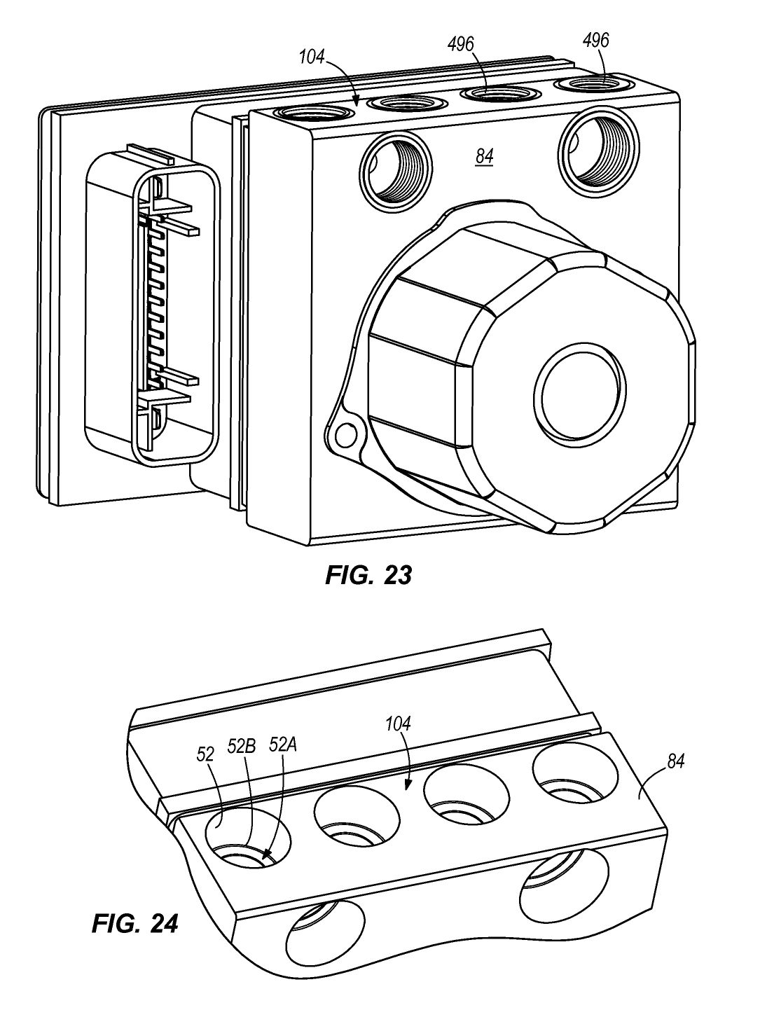

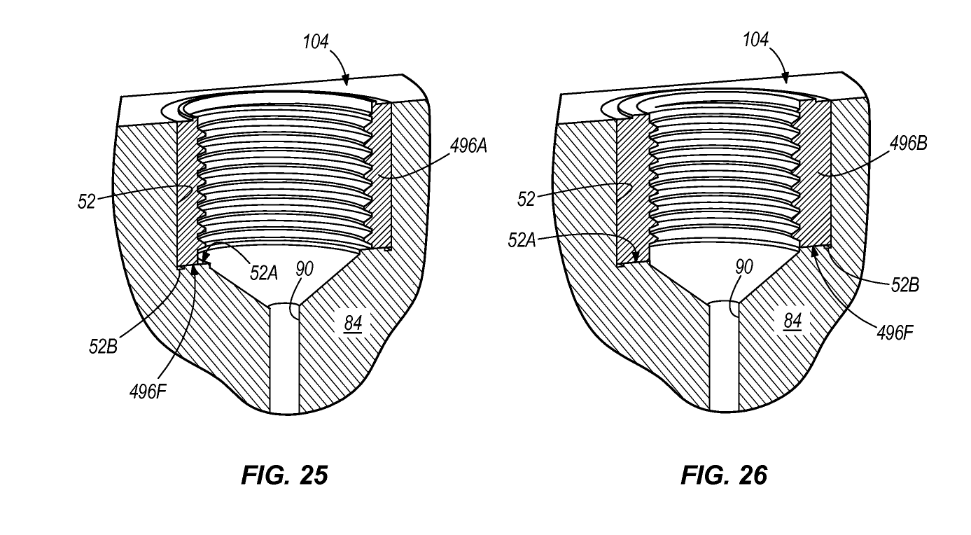

FIG. 23 illustrates yet another alternate port insert construction, identified as 496. The port inserts 496 do not have any knurled portion on their exterior for engaging with a brake-side connection port 52. Rather, the port inserts 496 are slightly smaller than the diameters of the corresponding brake-side connection ports 52 and are substantially completely received by the corresponding brake-side connection ports 52. Thus, substantially no portion of any of the port inserts 496 extends beyond the exterior surface 104 of the pump housing 84 (i.e., the distal end of each port insert 496 is substantially flush with the exterior surface 104). Each port insert 496 has a proximal axial end face 496F for welding the port insert 496 to the pump housing 84. In particular, the pump housing 84 is modified with a welding relief or undercut 52B at the bottom 52A of each of the brake-side connection ports 52, and the axial end face 496F can be ultrasonically welded to the pump housing 84 at this location. Other constructions and processes may alternately be provided. FIGS. 25 and 26 illustrate two particular constructions 496A, 496B, each conforming to the above description of the port insert 496, but being provided with alternate interior configurations (i.e., different internal threads) to accommodate various brake line fittings.

Although the above description of the various port inserts, the offset between the axes A1, A2, and the associated effects and advantages is focused on the brake-side connection ports 52, the same can generally be applied to the actuator-side connection ports 44 if desired.

Various features and advantages of the invention are set forth in the following claims.

What is claimed is:

1. A hydraulic unit for a braking system, the hydraulic unit comprising:
at least one motor-driven pump;
a pump housing configured to receive the at least one motor-driven pump;
a plurality of connection ports provided in the pump housing as bores intersecting an exterior surface of the pump housing and configured to be fluidly coupled with corresponding external brake lines; and
a plurality of internal fluid passages provided inside the pump housing, including a plurality of connector passages, each in direct fluid communication with a corresponding one of the plurality of connection ports;
wherein at least one of the plurality of connection ports defines a first axis that is offset from a second axis defined by the corresponding connector passage.

2. The hydraulic unit of claim 1, wherein the first axis and the second axis are parallel.

3. The hydraulic unit of claim 1, further comprising a plurality of port inserts corresponding to the plurality of connection ports, wherein each of the plurality of port inserts is fitted into a corresponding one of the plurality of connection ports and is configured to receive a corresponding external brake line.

4. The hydraulic unit of claim 3, wherein each of the plurality of port inserts is positioned in the bore of the corresponding one of the plurality of connection ports in a position spaced from a bottom of the bore.

5. The hydraulic unit of claim 4, further comprising a filter positioned between each of the plurality of port inserts and the corresponding bottoms of the bores of the plurality of connection ports.

6. The hydraulic unit of claim 1, wherein at least two of the plurality of connection ports define respective first axes that are offset from corresponding second axes of the corresponding connector passages.

7. The hydraulic unit of claim 1, wherein all of the plurality of connection ports define respective first axes that are offset from corresponding second axes of the corresponding connector passages.

8. The hydraulic unit of claim 1, wherein all of the connector passages are arranged in a row with the respective second axes lying in a common plane, and wherein the first axis of the at least one of the plurality of connection ports is not positioned in the plane.

9. The hydraulic unit of claim 8, wherein each of the plurality of connection ports defines a respective first axis, and wherein none of the first axes are positioned in the plane.

10. The hydraulic unit of claim 1, wherein the plurality of connection ports are brake-side connection ports, the hydraulic unit further comprising a plurality of actuator-side connection ports.

11. The hydraulic unit of claim 1, wherein the exterior surface of the pump housing is a single planar surface of the pump housing.

12. The hydraulic unit of claim 1, wherein each of the plurality of connector passages intersects with a conical tapered bottom end of the bore forming the corresponding one of the plurality of connection ports.

13. The hydraulic unit of claim 1, wherein each one of the plurality of connection ports is in fluid communication with an additional internal connector passage centered on a third axis that is substantially perpendicular to the first axis.
